(19) United States
(12) Patent Application Publication
(10) Pub. No.: US 2003/0072517 A1
(43) Pub. Date: Apr. 17, 2003

(54) System for compensating for distortions in optical signals

(76) Inventor: Christoph Glingener, Feldkirchen-Westerham (DE)

Correspondence Address: Bell, Boyd & Lloyd LLC, P.O. Box 1135, Chicago, IL, 60690, US

(21) Appl. No.: 10/254,162

(22) Filed: Sep. 25, 2002

(30) Foreign Application Priority Data
Sep. 25, 2001 (DE) 101 47 169.6

(51) Int. Cl. G02B 6/26; G02B 6/27

(52) U.S. Cl. 385/15; 385/27; 385/11

(57) ABSTRACT

A system for compensating for distortions in optical signals, wherein the series connection of a controllable polarization-dependent delay element and of a controllable filter allows good signal distortion correction; for example, due to group delay dispersion or polarization mode dispersion. The series circuit also may contain further devices for signal improvement.

### BACKGROUND OF THE INVENTION

An optical fiber is not an ideal medium for transferring optical signals. The range and signal quality are limited by various optical effects; particularly, when transferring data with high bit rates. Wavelength-dependent attenuation can be compensated for by appropriate amplifiers. Other effects, such as delay/group dispersion, self-phase modulation and polarization mode dispersion have a particularly disruptive effect on the transfer of impulses, as they distort these significantly.

Special fibers are used to compensate for delay dispersion, the delay characteristics of which are inverted with respect to the transfer fibers. The use of Bragg filters for dispersion compensation dispersion is also known from “Fiber Optic Communication Systems”, 2^{nd} Edition, G. P. Agrawal, page 444. The use of a transverse filter, which allows simultaneous dispersion compensation with a number of wavelengths (WDM system) in a periodic filter pattern based on the channel interval is known from patent application EP 0 740 173 A2. Automatic filter optimization systems are already known.

Various methods and control arrangements for PMD compensation are known from OFC 2000 Pepa ThH1, pages 110 to 112 “PMD mitigation techniques and effectiveness in installed fibre” by H. Bühlow.

A method for PMD compensation via a first order optical compensator is compared with an adjustable electrical transverse filter in “Optics Communications”, Vol. 182, No. 1-3, pp. 135-141.

An adjustable electrical transverse filter, which is used for PMD and delay dispersion compensation is described in ECOC'99 Vol. 2, pp. 138-139, H. Bühlow et al.

A common feature of the known method and arrangements is the fact that they only allow inadequate compensation for high data rates from 40 GBit/s.

An object of the present invention is to specify a universally deployable arrangement, which is relatively simple to construct and which can be used to compensate for the major distortions caused by optical transfer.

### SUMMARY OF THE INVENTION

Accordingly, in an embodiment of the present invention, a system is provided for compensating for distortions in optical signals, wherein the system includes a series circuit having a controllable polarization-dependent delay element and a controllable optical filter for signal distortion correction, and a control device for assessing quality of a corrected optical signal or a demodulated electrical signal and for transmitting control signals to the delay element and the optical filter.

In an embodiment, the series circuit further includes a number of delay elements and optical filters connected in series.

In an embodiment, the system includes a number of the series circuits.

In an embodiment, the series circuit includes a further non-adjustable optical filter for signal distortion correction.

In an embodiment, the polarization-dependent delay element contains a delay element with a fixed delay.

In an embodiment, the series circuit further includes a dispersion compensation element.

In an embodiment, both the delay element and the optical filter are controlled separately.

In an embodiment, the optical filter is an FIR filter.

In an embodiment, the system further includes an optical electronic converter and an electrical filter connected downstream from the series circuit for electronic signal optimization.

In an embodiment, the optical filter is periodic based on a channel interval of a WDM signal.

A major advantage of the system of the present invention is the purely optical design. The demodulating and squaring effect of a photodiode causes conversion to electrical signals to produce a data loss (carrier, phase), which restricts the compensation options. The optical components used are uncomplicated and relatively simple to activate. It is particularly suited to adaptive PMD control. As the parameters of the arrangement are automatically adjusted, irrespective of the physical cause, so that optimum reception is achieved, optimum reception quality is always achieved even when a number of effects occur simultaneously; for example, PMD, self-phase modulation and delay dispersion.

Multiplying the arrangement makes it possible to largely compensate for higher order non-linear distortions, such as third order PMD, as well. In addition to the distortions caused by the characteristics of the transfer fiber, distortions caused by transmitter or receiver devices also can be compensated for (to some extent).

The system according to the present invention advantageously can be used with permanent or permanently adjustable compensation devices, which produce basic compensation.

Additional features and advantages of the present invention are described in, and will be apparent from, the following Detailed Description of the Invention and the Figures.

### BRIEF DESCRIPTION OF THE FIGURES

FIG. 1 shows a basic circuit diagram of the system according to the present invention.

FIG. 2 shows an extended system for compensating for higher order distortions.

### DETAILED DESCRIPTION OF THE INVENTION

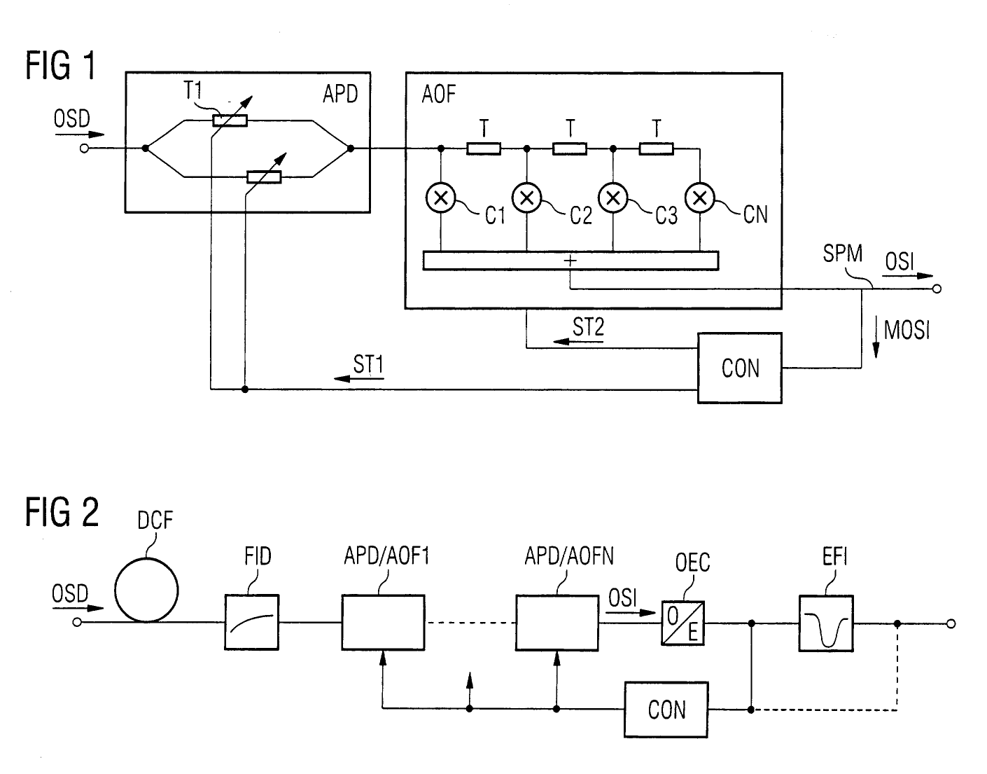

FIG. 1 shows the series connection of a polarization-dependent adjustable time element APD and of an adjustable optical filter AOF as the major distortion correction element. A controlled polarization regulator (not shown) is used to achieve constant polarization. A distorted optical signal OSD is fed to the polarization-dependent delay element APD. This contains a splitter SPL for dividing into signal components assigned to two orthogonal polarization levels, which are supplied via two routes with adjustable delay elements T1, T2, which determine the different spread speeds of the optical wave in both polarization levels (an adjustable and a permanent delay element also can be used). The signal components are combined again by a combiner (coupler) COM. The adjustable optical filter AOF is, for example, in the form of an analog transverse filter, the complex coefficients C1, C2, C3, . . . of which are adjustable. However, all known filter structures or a combination of a transverse filter (FIR filter) and a feedback filter (IIR filter) can be used.

A test signal MOSI derived from the compensated output signal OSI by a splitter SPM is fed to a control device CON, which checks the signal quality of the corrected optical signal OSI. For this, the optical signal is at present first converted to an electrical signal (demodulated), which also can be derived from the optoelectrical converter of the receiver. The delay elements T1 and T2 are adjusted via a first control signal ST1, and the filter coefficients by a second control signal T2.

Control of the delay element and filter can be serial in time, with a number of iteration stages possibly required to achieve an optimally corrected signal OSI. This is expedient if the optical diagrams are assessed. Control, however, also may be simultaneous for the delay element and the filter; for example, via analysis of the spectrum of the corrected signal.

The polarization-dependent delay element may, in principle, be designed in any way. At present, double refracting materials, such as lithium niobate (LINbO3), seem particularly advantageous. The polarization-dependent delay element may be first or higher order. Also, a number of delay elements or optical filters or compensation modules can be connected in series according to FIG. 1.

FIG. 2 shows the basic circuit diagram of a series circuit of optical compensation modules APD/ADF1 to APD/ADFN, each of which contains a series circuit of an adjustable time element APD and an adjustable filter OAF. This system can be used to compensate for higher order distortions. A number of polarization-dependent delay elements and a number of filters also can be connected in series.

While in high bit rate optical arrangements the PDM is compensated for on a channel basis, delay dispersion and self-phase modulation can be compensated for by designing the optical filter in WDM arrangements so that it is periodic, based on the channel interval. PMD compensation only takes place on a channel basis after distribution of the WDM signal to individual channels.

The series circuit also may contain non-adjustable or permanently adjustable elements, such as a dispersion compensation element DCF, generally a dispersion compensation fiber, a dispersion compensation filter element FID with fixed coefficients (also a number of permanently adjusted filters), which already produce basic compensation. Also an optoelectrical converter OEC can be used to connect an electrical filter EFI downstream from the series circuit described above for residual compensation purposes. This also can be controlled adaptively.

Although the present invention has been described with reference to specific embodiments, those of skill in the art will recognize that changes may be made thereto without departing from the spirit and scope of the present invention as set forth in the hereafter appended claims.

1. A system for compensating for distortions in optical signals, comprising:
a series circuit including a controllable polarization-dependent delay element and a controllable optical filter for signal distortion correction; and
a control device for assessing quality of one of a corrected optical signal and a demodulated electrical signal, and for transmitting control signals to the delay element and the optical filter.

2. A system for compensating for distortions in optical signals as claimed in claim 1, wherein the series circuit further includes a plurality of delay elements and optical filters connected in series.

3. A system for compensating for distortions in optical signals as claimed in claim 1, wherein the system includes a plurality of the series circuits.

4. A system for compensating for distortions in optical signals as claimed in claim 1, wherein the series circuit includes a further non-adjustable optical filter for signal distortion correction.

5. A system for compensating for distortions in optical signals as claimed in claim 1, wherein the polarization-dependent delay element contains a delay element with a fixed delay.

6. A system for compensating for distortions in optical signals as claimed in claim 1, wherein the series circuit further includes a dispersion compensation element.

7. A system for compensating for distortions in optical signals as claimed in claim 1, wherein the delay element and the optical filter are controlled separately.

8. A system for compensating for distortions in optical signals as claimed in claim 1, wherein the optical filter is an FIR filter.

9. A system for compensating for distortions in optical signals as claimed in claim 1, further comprising an optoelectronic converter and an electrical filter connected downstream from the series circuit for electronic signal optimization.

10. A system for compensating for distortions in optical signals as claimed in claim 1, wherein the optical filter is periodic based on a channel interval of a WDM signal.
